(19) United States
(12) Patent Application Publication
(10) Pub. No.: US 2024/0049230 A1
(43) Pub. Date: Feb. 8, 2024

(54) SYSTEMS AND METHODS OF UWB CONFIGURATION FOR APPLICATION TYPES

(71) Applicant: Meta Platforms Technologies, LLC, Menlo Park, CA (US)

(72) Inventors: Kangjin Yoon, Menlo Park, CA (US); Chunyu Hu, Saratoga, CA (US); Kanji Mavji Kerai, London (GB)

(73) Assignee: Meta Platforms Technologies, LLC, Menlo Park, CA (US)

(21) Appl. No.: 18/230,557

(22) Filed: Aug. 4, 2023

Related U.S. Application Data
(60) Provisional application No. 63/396,103, filed on Aug. 8, 2022.
(60) Provisional application No. 63/448,789, filed on Feb. 28, 2023.

(51) Int. Cl. H04W 72/20; G01S 13/76

(52) U.S. Cl. CPC H04W 72/20; G01S 13/765

(57) ABSTRACT

Systems and methods for slot scheduling may include a first wireless communication device that generates an information element (IE) for scheduling slots for one or more functionalities of a plurality of functionalities, for ultra-wideband (UWB) transmissions between the first wireless communication device and a second wireless communication device. The IE may include, for each respective functionality of the one or more functionalities, a corresponding scheduling list element defining slot scheduling for the respective functionality. The first wireless communication device may transmit the IE to the second wireless communication device.

### CROSS-REFERENCE TO RELATED APPLICATIONS

This application claims the benefit of and priority to U.S. Prov. Application No. 63/396,103, filed Aug. 8, 2022 and U.S. Prov. Application No. 63/448,789, filed Feb. 28, 2023, the entire contents of each of which are incorporated herein by reference.

### FIELD OF DISCLOSURE

The present disclosure is generally related to ultra-wideband devices, including but not limited to systems and methods ultra-wideband configuration for application types.

### BACKGROUND

Ultra-wideband (UWB) technology provides for precise ranging between two devices having UWB devices or transceivers. Some devices may include UWB sensors as well as antennas/systems for supporting other types of wireless transmission technology outside of UWB (e.g., out-of-band), such as Wi-Fi, cellular, Bluetooth, etc. Some devices may use UWB for other applications, such as data communication, multi-millisecond ranging, time difference of arrival (TDoA), or sensing.

### SUMMARY

Various embodiments disclosed herein are related to systems, methods, and devices for ultra-wideband configuration for application types. A first wireless communication device may generate a control information element (IE) for configuring one or more functionalities of a plurality of functionalities, for ultra-wideband (UWB) transmissions between the first wireless communication device and a second wireless communication device. The first wireless communication device may transmit a message that includes the control IE to the second wireless communication device.

In some embodiments, the control IE includes a plurality of fields for indicating whether configuration information corresponding to a respective functionality of the plurality of functionalities is present in the control IE. In some embodiments, the plurality of fields may include a first field for indicating whether configuration information relating to ranging control is present in the control IE, a second field for indicating whether configuration information relating to data communication control is present in the control IE, a third field for indicating whether configuration information relating to sensing control is present in the control IE, and/or a fourth field for indicating whether configuration information relating to time difference of arrival control is present in the control IE. In some embodiments, a length of the control IE depends on a number of the plurality of fields that each has a value indicating presence of corresponding configuration information.

In some embodiments, the first wireless communication device may transmit one or more transmissions with the one or more functionalities to the second wireless communication device, according to the control IE. In some embodiments, the plurality of functionalities may include at least one of ranging, data communication, sensing, or control of time difference of arrival. In some embodiments, the first wireless communication device may generate the control IE at an application layer, according to a resource of the first wireless communication device and capabilities of the first wireless communication device. In some embodiments, the control IE includes information regarding configuring contention-based communication between the first wireless communication device and the second wireless communication device. In some embodiments, the control IE includes information regarding configuring an acknowledgement type to be used for acknowledgements between the first wireless communication device and the second wireless communication device.

### BRIEF DESCRIPTION OF THE DRAWINGS

The accompanying drawings are not intended to be drawn to scale. Like reference numbers and designations in the various drawings indicate like elements. For purposes of clarity, not every component can be labeled in every drawing.

FIG. 1 is a diagram of a system environment including a virtual/augmented reality system, according to an example implementation of the present disclosure.

FIG. 2 is a diagram of a head wearable display, according to an example implementation of the present disclosure.

FIG. 3 is a block diagram of an artificial reality environment, according to an example implementation of the present disclosure.

FIG. 4 is a block diagram of another artificial reality environment, according to an example implementation of the present disclosure.

FIG. 5 is a block diagram of another artificial reality environment, according to an example implementation of the present disclosure.

FIG. 6 is a block diagram of a computing environment, according to an example implementation of the present disclosure.

FIG. 7 is a block diagram of a system for ultra-wideband (UWB) configuration for application types, according to an example implementation of the present disclosure.

FIG. 8A-FIG. 8D are diagrams of example information element (IE) (e.g., generated by the system of FIG. 7), according to example implementations of the present disclosure.

FIG. 9 is a flowchart showing an example method of UWB configuration for application types, according to an example implementation of the present disclosure.

### DETAILED DESCRIPTION

Before turning to the figures, which illustrate certain embodiments in detail, it should be understood that the present disclosure is not limited to the details or methodology set forth in the description or illustrated in the figures. It should also be understood that the terminology used herein is for the purpose of description only and should not be regarded as limiting.

Disclosed herein are embodiments related to devices operating in the ultra-wideband (UWB) spectrum. In various embodiments, UWB devices (including pucks, anchors, UWB beacons, UWB antennas, etc.) operate in the 3-10 GHz unlicensed spectrum using 500+ MHz channels which may require low power for transmission. For example, the transmit power spectral density (PSD) for some devices may be limited to −41.3 dBm/MHz. On the other hand, UWB may have transmit PSD values in the range of −5 to +5 dBm/MHz range, averaged over 1 ms, with a peak power limit of 0 dBm in a given 50 MHz band. Using simple modulation and spread spectrum, UWB devices may achieve reasonable resistance to Wi-Fi and Bluetooth interference (as well as resistance to interference with other UWB devices within a shared or common environment) for very low data rates (e.g., 10s to 100s Kbps) and may have large processing gains. However, for higher data rates (e.g., several Mbps), the processing gains may not be sufficient to overcome co-channel interference from Wi-Fi or Bluetooth. According to the embodiments described herein, the systems and methods described herein may operate in frequency bands that do not overlap with Wi-Fi and Bluetooth, but may have good global availability based on regulatory requirements. Since regulatory requirements make the 7-8 GHz spectrum the most widely available globally (and Wi-Fi is not present in this spectrum), the 7-8 GHz spectrum may operate satisfactory both based on co-channel interference and processing gains.

Some implementations of UWB may focus on precision ranging, security, and low to moderate rate data communication. For example, employing UWB devices as described herein allows for a determination of a relative location between two or more UWB devices with precision (e.g., determination of devices within 5-10 degrees of rotation and a distance within 0.5 mm). The determination of the location, position, tilt, and/or rotation of UWB devices relative to one another enables, among other features, clear spatial audio content to be communicated between the UWB devices (and/or between multiple other devices such as a first device and any peripheral devices). Spatial audio, in some aspects, refers to three-dimensional audio, where three-dimensional audio describes the phenomenon/situation of audio emanating from (or appearing to emanate from) various locations. In some embodiments, the audio signal may seem to originate within objects. In contrast to spatial content, head-locked content refers to content that is fixed with respect to a user. For example, a user wearing a head wearable device (HWD) configured with spatial audio capabilities may experience audio behind the user, in front of the user, above the user, to the side of the user, below the user, and so on. In contrast, a user wearing a HWD configured with head-locked rotation may experience a fixed audio sound emanating from a fixed location, regardless of the user's rotation/movement in an environment.

In some embodiments, sensors (e.g., inertial measurement units, magnetometers, cameras, etc.) can provide head locked rotation data corresponding to the movement and/or orientation of the sensors or an associated object. However, such collected sensor data may be affected by signal drift. Moreover, the collected sensor data may be limited in its ability to provide/maintain accurate positions in space. Additionally, the collected sensor data may be limited in its capacity to describe the distance of objects relative to position and rotations relative to other objects. In some embodiments, sensor data may be used in conjunction with such techniques as virtual reality simultaneous localization and mapping (VR SLAM) and object detection to enable spatial audio content to be communicated. However, utilizing a sensor such as a camera to facilitate spatial audio content implies that the camera would always be on, consuming excessive power and utilizing real estate on a limited space device (e.g., a head wearable device).

As UWB employs relatively simple modulation, it may be implemented at low cost and low power consumption. Accordingly, UWB devices may be employed to track movement and/or orientation so as to support, process and/or communicate spatial audio content. In AR/VR applications, link budget calculations for an AR/VR controller link indicate that the systems and methods described herein may be configured for effective data throughput ranging from −2 to 31 Mbps (e.g., with 31 Mbps being the maximum possible rate in the latest 802.15.4z standard), which may depend on body loss assumptions. Using conservative body loss assumptions, the systems and methods described herein should be configured for data throughput of up to approximately 5 Mbps, which may be sufficient to meet the data throughput performance standards for AR/VR links. With a customized implementation, data throughput rate could be increased beyond 27 Mbps (e.g., to 54 Mbps), but with a possible loss in link margin.

Using UWB allows one or more devices to determine their relative distance to one another. The determination of a relative distance from a device can be used to anchor a user in a digital/physical/audio environment. Accordingly, spatial audio content can be output from a known source location (e.g., an audio source) and be received by a user coupled to a device based on the position/orientation of the user coupled to the device and the audio source. In some embodiments, sensors (such as IMUs and magnetometers) may collect data in conjunction with data collected from UWB devices to achieve a high sample rate relative to the determined location and/or rotation. Various applications, use cases, and further implementations of the systems and methods described herein are described in greater detail below.

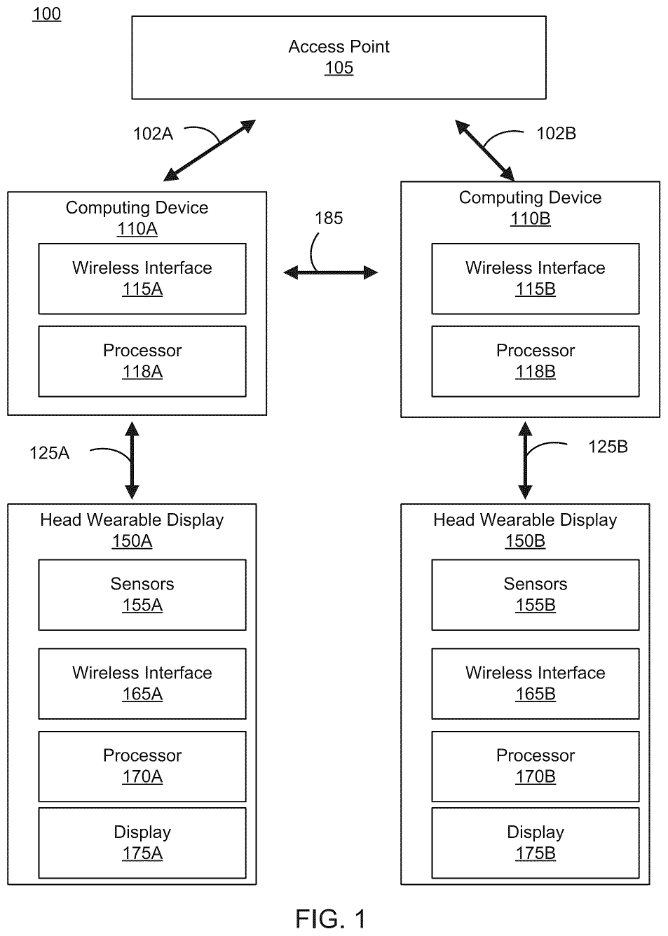

FIG. 1 is a block diagram of an example virtual/augmented reality system environment 100. The environment 100 may be used to support a virtual reality environment, an augmented reality environment, and/or an artificial reality environment. In some embodiments, the artificial reality system environment 100 includes an access point (AP) 105, one or more HWDs 150 (e.g., HWD 150A, 150B), and one or more computing devices 110 (computing devices 110A, 110B; sometimes referred to as devices or consoles) providing data for artificial reality to the one or more HWDs 150. The access point 105 may be a router or any network device allowing one or more computing devices 110 and/or one or more HWDs 150 to access a network (e.g., the Internet). The access point 105 may be replaced by any communication device (cell site). A computing device 110 may be a custom device or a mobile device that can retrieve content from the access point 105, and provide image data of artificial reality to a corresponding HWD 150. Each HWD 150 may present the image of the artificial reality to a user according to the image data. In some embodiments, the artificial reality system environment 100 includes more, fewer, or different components than shown in FIG. 1. In some embodiments, the computing devices 110A, 110B communicate with the access point 105 through wireless links 102A, 102B (e.g., interlinks), respectively. In some embodiments, the computing device 110A communicates with the HWD 150A through a wireless link 125A (e.g., intralink), and the computing device 110B communicates with the HWD 150B through a wireless link 125B (e.g., intralink). In some embodiments, functionality of one or more components of the artificial reality system environment 100 can be distributed among the components in a different manner than is described here. For example, some of the functionality of the computing device 110 may be performed by the HWD 150. For example, some of the functionality of the HWD 150 may be performed by the computing device 110.

In some embodiments, the HWD 150 is an electronic component that can be worn by a user and can present or provide an artificial reality experience to the user. The HWD 150 may be referred to as, include, or be part of a head mounted display (HMD), head mounted device (HMD), head wearable device (HWD), head worn display (HWD) or head worn device (HWD). The HWD 150 may render one or more images, video, audio, or some combination thereof to provide the artificial reality experience to the user. In some embodiments, audio is presented via an external device (e.g., speakers and/or headphones) that receives audio information from the HWD 150, the computing device 110, or both, and presents audio based on the audio information. In some embodiments, the HWD 150 includes sensors 155, a wireless interface 165, a processor 170, and a display 175. These components may operate together to detect a location of the HWD 150 and a gaze direction of the user wearing the HWD 150, and render an image of a view within the artificial reality corresponding to the detected location and/or orientation of the HWD 150. In other embodiments, the HWD 150 includes more, fewer, or different components than shown in FIG. 1.

In some embodiments, the sensors 155 include electronic components or a combination of electronic components and software components that detects a location and an orientation of the HWD 150. Examples of the sensors 155 can include: one or more imaging sensors, one or more accelerometers, one or more gyroscopes, one or more magnetometers, or another suitable type of sensor that detects motion and/or location. For example, one or more accelerometers can measure translational movement (e.g., forward/back, up/down, left/right) and one or more gyroscopes can measure rotational movement (e.g., pitch, yaw, roll). In some embodiments, the sensors 155 detect the translational movement and the rotational movement, and determine an orientation and location of the HWD 150. In one aspect, the sensors 155 can detect the translational movement and the rotational movement with respect to a previous orientation and location of the HWD 150, and determine a new orientation and/or location of the HWD 150 by accumulating or integrating the detected translational movement and/or the rotational movement. Assuming for an example that the HWD 150 is oriented in a direction 25 degrees from a reference direction, in response to detecting that the HWD 150 has rotated 20 degrees, the sensors 155 may determine that the HWD 150 now faces or is oriented in a direction 45 degrees from the reference direction. Assuming for another example that the HWD 150 was located two feet away from a reference point in a first direction, in response to detecting that the HWD 150 has moved three feet in a second direction, the sensors 155 may determine that the HWD 150 is now located at a vector multiplication of the two feet in the first direction and the three feet in the second direction.

In some embodiments, the wireless interface 165 includes an electronic component or a combination of an electronic component and a software component that communicates with the computing device 110. In some embodiments, the wireless interface 165 includes or is embodied as a transceiver for transmitting and receiving data through a wireless medium. The wireless interface 165 may communicate with a wireless interface 115 of a corresponding computing device 110 through a wireless link 125 (e.g., intralink). The wireless interface 165 may also communicate with the access point 105 through a wireless link (e.g., interlink). Examples of the wireless link 125 include a near field communication link, Wi-Fi direct, Bluetooth, or any wireless communication link. In some embodiments, the wireless link 125 may include one or more ultra-wideband communication links, as described in greater detail below. Through the wireless link 125, the wireless interface 165 may transmit to the computing device 110 data indicating the determined location and/or orientation of the HWD 150, the determined gaze direction of the user, and/or hand tracking measurement. Moreover, through the wireless link 125, the wireless interface 165 may receive from the computing device 110 image data indicating or corresponding to an image to be rendered.

In some embodiments, the processor 170 includes an electronic component or a combination of an electronic component and a software component that generates one or more images for display, for example, according to a change in view of the space of the artificial reality. In some embodiments, the processor 170 is implemented as one or more graphical processing units (GPUs), one or more central processing unit (CPUs), or a combination of them that can execute instructions to perform various functions described herein. The processor 170 may receive, through the wireless interface 165, image data describing an image of artificial reality to be rendered, and render the image through the display 175. In some embodiments, the image data from the computing device 110 may be encoded, and the processor 170 may decode the image data to render the image. In some embodiments, the processor 170 receives, from the computing device 110 through the wireless interface 165, object information indicating virtual objects in the artificial reality space and depth information indicating depth (or distances from the HWD 150) of the virtual objects. In one aspect, according to the image of the artificial reality, object information, depth information from the computing device 110, and/or updated sensor measurements from the sensors 155, the processor 170 may perform shading, reprojection, and/or blending to update the image of the artificial reality to correspond to the updated location and/or orientation of the HWD 150.

In some embodiments, the display 175 is an electronic component that displays an image. The display 175 may, for example, be a liquid crystal display or an organic light emitting diode display. The display 175 may be a transparent display that allows the user to see through. In some embodiments, when the HWD 150 is worn by a user, the display 175 is located proximate (e.g., less than 3 inches) to the user's eyes. In one aspect, the display 175 emits or projects light towards the user's eyes according to image generated by the processor 170. The HWD 150 may include a lens that allows the user to see the display 175 in a close proximity.

In some embodiments, the processor 170 performs compensation to compensate for any distortions or aberrations. In one aspect, the lens introduces optical aberrations such as a chromatic aberration, a pin-cushion distortion, barrel distortion, etc. The processor 170 may determine a compensation (e.g., predistortion) to apply to the image to be rendered to compensate for the distortions caused by the lens, and apply the determined compensation to the image from the processor 170. The processor 170 may provide the predistorted image to the display 175.

In some embodiments, the computing device 110 is an electronic component or a combination of an electronic component and a software component that provides content to be rendered to the HWD 150. The computing device 110 may be embodied as a mobile device (e.g., smart phone, tablet PC, laptop, etc.). The computing device 110 may operate as a soft access point. In one aspect, the computing device 110 includes a wireless interface 115 and a processor 118. These components may operate together to determine a view (e.g., a FOV of the user) of the artificial reality corresponding to the location of the HWD 150 and the gaze direction of the user of the HWD 150, and can generate image data indicating an image of the artificial reality corresponding to the determined view. The computing device 110 may also communicate with the access point 105, and may obtain AR/VR content from the access point 105, for example, through the wireless link 102 (e.g., interlink). The computing device 110 may receive sensor measurement indicating location and the gaze direction of the user of the HWD 150 and provide the image data to the HWD 150 for presentation of the artificial reality, for example, through the wireless link 125 (e.g., intralink). In other embodiments, the computing device 110 includes more, fewer, or different components than shown in FIG. 1.

In some embodiments, the wireless interface 115 is an electronic component or a combination of an electronic component and a software component that communicates with the HWD 150, the access point 105, other computing device 110, or any combination of them. In some embodiments, the wireless interface 115 includes or is embodied as a transceiver for transmitting and receiving data through a wireless medium. The wireless interface 115 may be a counterpart component to the wireless interface 165 to communicate with the HWD 150 through a wireless link 125 (e.g., intralink). The wireless interface 115 may also include a component to communicate with the access point 105 through a wireless link 102 (e.g., interlink). Examples of wireless link 102 include a cellular communication link, a near field communication link, Wi-Fi, Bluetooth, 60 GHz wireless link, ultra-wideband link, or any wireless communication link. The wireless interface 115 may also include a component to communicate with a different computing device 110 through a wireless link 185. Examples of the wireless link 185 include a near field communication link, Wi-Fi direct, Bluetooth, ultra-wideband link, or any wireless communication link. Through the wireless link 102 (e.g., interlink), the wireless interface 115 may obtain AR/VR content, or other content from the access point 105. Through the wireless link 125 (e.g., intralink), the wireless interface 115 may receive from the HWD 150 data indicating the determined location and/or orientation of the HWD 150, the determined gaze direction of the user, and/or the hand tracking measurement. Moreover, through the wireless link 125 (e.g., intralink), the wireless interface 115 may transmit to the HWD 150 image data describing an image to be rendered. Through the wireless link 185, the wireless interface 115 may receive or transmit information indicating the wireless link 125 (e.g., channel, timing) between the computing device 110 and the HWD 150. According to the information indicating the wireless link 125, computing devices 110 may coordinate or schedule operations to avoid interference or collisions.

The processor 118 can include or correspond to a component that generates content to be rendered according to the location and/or orientation of the HWD 150. In some embodiments, the processor 118 includes or is embodied as one or more central processing units, graphics processing units, image processors, or any processors for generating images of the artificial reality. In some embodiments, the processor 118 may incorporate the gaze direction of the user of the HWD 150 and a user interaction in the artificial reality to generate the content to be rendered. In one aspect, the processor 118 determines a view of the artificial reality according to the location and/or orientation of the HWD 150. For example, the processor 118 maps the location of the HWD 150 in a physical space to a location within an artificial reality space, and determines a view of the artificial reality space along a direction corresponding to the mapped orientation from the mapped location in the artificial reality space. The processor 118 may generate image data describing an image of the determined view of the artificial reality space, and transmit the image data to the HWD 150 through the wireless interface 115. The processor 118 may encode the image data describing the image, and can transmit the encoded data to the HWD 150. In some embodiments, the processor 118 generates and provides the image data to the HWD 150 periodically (e.g., every 11 ms or 16 ms).

In some embodiments, the processors 118, 170 may configure or cause the wireless interfaces 115, 165 to toggle, transition, cycle or switch between a sleep mode and a wake up mode. In the wake up mode, the processor 118 may enable the wireless interface 115 and the processor 170 may enable the wireless interface 165, such that the wireless interfaces 115, 165 may exchange data. In the sleep mode, the processor 118 may disable (e.g., implement low power operation in) the wireless interface 115 and the processor 170 may disable the wireless interface 165, such that the wireless interfaces 115, 165 may not consume power or may reduce power consumption. The processors 118, 170 may schedule the wireless interfaces 115, 165 to switch between the sleep mode and the wake up mode periodically every frame time (e.g., 11 ms or 16 ms). For example, the wireless interfaces 115, 165 may operate in the wake up mode for 2 ms of the frame time, and the wireless interfaces 115, 165 may operate in the sleep mode for the remainder (e.g., 9 ms) of the frame time. By disabling the wireless interfaces 115, 165 in the sleep mode, power consumption of the computing device 110 and the HWD 150 can be reduced.

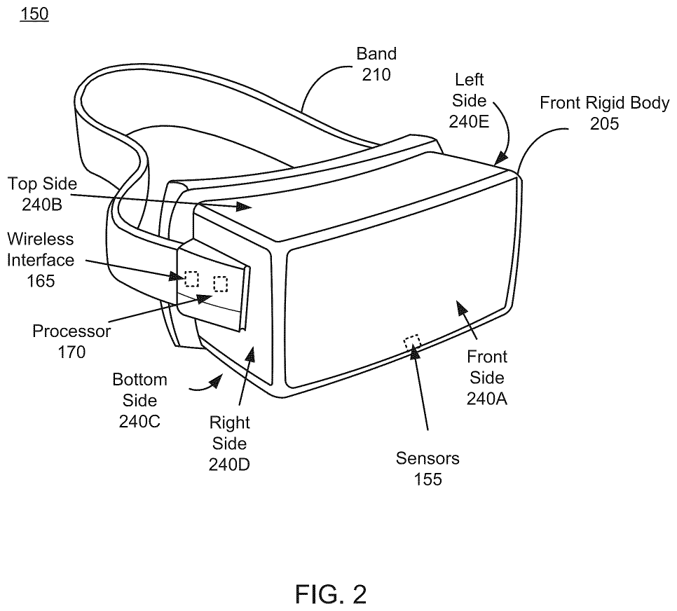

FIG. 2 is a diagram of a HWD 150, in accordance with an example embodiment. In some embodiments, the HWD 150 includes a front rigid body 205 and a band 210. The front rigid body 205 includes the electronic display 175 (not shown in FIG. 2), the lens (not shown in FIG. 2), the sensors 155, the eye trackers the communication interface 165, and the processor 170. In the embodiment shown by FIG. 2, the sensors 155 are located within the front rigid body 205, and may not be visible to the user. In other embodiments, the HWD 150 has a different configuration than shown in FIG. 2. For example, the processor 170, the eye trackers, and/or the sensors 155 may be in different locations than shown in FIG. 2.

In various embodiments, the devices in the environments described above may operate or otherwise use components which leverage communications in the ultra-wideband (UWB) spectrum. In various embodiments, UWB devices operate in the 3-10 GHz unlicensed spectrum using 500+ MHz channels which may require low power for transmission. For example, the transmit power spectral density (PSD) for some systems may be limited to −41.3 dBm/MHz. On the other hand, UWB may have transmit PSD values in the range of −5 to +5 dBm/MHz range, averaged over 1 ms, with a peak power limit of 0 dBm in a given 50 MHz band. Using simple modulation and spread spectrum, UWB devices may achieve reasonable resistance to Wi-Fi and Bluetooth interference (as well as resistance to interference with other UWB devices located in the environment) for very low data rates (e.g., 10s to 100s Kbps) and may have large processing gains. However, for higher data rates (e.g., several Mbps), the processing gains may not be sufficient to overcome co-channel interference from Wi-Fi or Bluetooth. According to the embodiments described herein, the systems and methods described herein may operate in frequency bands that do not overlap with Wi-Fi and Bluetooth, but may have good global availability based on regulatory requirements. Since regulatory requirements make the 7-8 GHz spectrum the most widely available globally (and Wi-Fi is not present in this spectrum), the 7-8 GHz spectrum may operate satisfactory both based on co-channel interference and processing gains.

Some implementations of UWB may focus on precision ranging, security, and for low-to-moderate rate data communication. As UWB employs relatively simple modulation, it may be implemented at low cost and low power consumption. In AR/VR applications (or in other applications and use cases), link budget calculations for an AR/VR controller link indicate that the systems and methods described herein may be configured for effective data throughput ranging from −2 to 31 Mbps (e.g., with 31 Mbps being the maximum possible rate in the latest 802.15.4z standard), which may depend on body loss assumptions

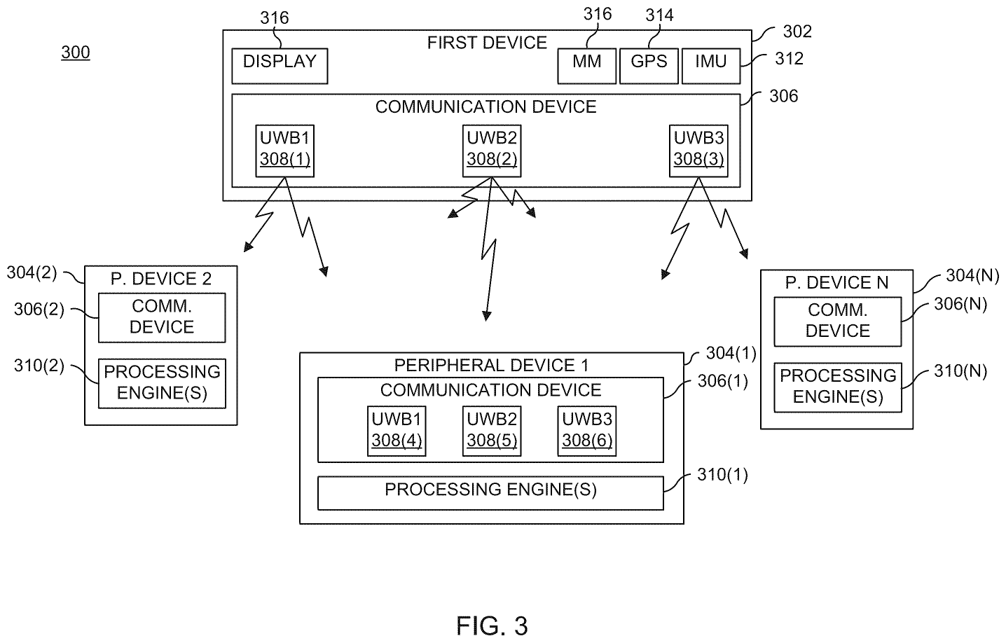

Referring now to FIG. 3, depicted is a block diagram of an artificial reality environment 300. The artificial reality environment 300 is shown to include a first device 302 and one or more peripheral devices 304(1)-304(N) (also referred to as “peripheral device 304,” “second device 304,” or “device 304”). The first device 302 and peripheral device(s) 304 may each include a communication device 306 including a plurality of UWB devices 308. A set of UWB devices 308 may be spatially positioned/located (e.g., spaced out) relative to each other on different locations on/in the first device 302 or the peripheral device 304, so as to maximize UWB coverage and/or to enhance/enable specific functionalities. The UWB devices 308 may be or include antennas, sensors, or other devices and components designed or implemented to transmit and receive data or signals in the UWB spectrum (e.g., between 3.1 GHz and 10.6 GHz) and/or using UWB communication protocol. In some embodiments, one or more of the devices 302, 304 may include various processing engines 310. The processing engines 310 may be or include any device, component, machine, or other combination of hardware and software designed or implemented to control the devices 302, 304 based on UWB signals transmitted and/or received by the respective UWB devices 308.

As noted above, the environment 300 may include a first device 302. The first device 302 may be or include a wearable device, such as the HWD 150 described above, a smart watch, AR glasses, or the like. In some embodiments, the first device 302 may include a mobile device (e.g., a smart phone, tablet, console device, or other computing device). The first device 302 may be communicably coupled with various other devices 304 located in the environment 300. For example, the first device 302 may be communicably coupled to one or more of the peripheral devices 304 located in the environment 300. The peripheral devices 304 may be or include the computing device 110 described above, a device similar to the first device 302 (e.g., a HWD 150, a smart watch, mobile device, etc.), an automobile or other vehicle, a beacon transmitting device located in the environment 300, a smart home device (e.g., a smart television, a digital assistant device, a smart speaker, etc.), a smart tag configured for positioning on various devices, etc. In some embodiments, the first device 302 may be associated with a first entity or user and the peripheral devices 304 may be associated with a second entity or user (e.g., a separate member of a household, or a person/entity unrelated to the first entity).

In some embodiments, the first device 302 may be communicably coupled with the peripheral device(s) 304 following a pairing or handshaking process. For example, the first device 302 may be configured to exchange handshake packet(s) with the peripheral device(s) 304, to pair (e.g., establish a specific or dedicated connection or link between) the first device 302 and the peripheral device 304. The handshake packet(s) may be exchanged via the UWB devices 308, or via another wireless link 125 (such as one or more of the wireless links 125 described above). Following pairing, the first device 302 and peripheral device(s) 304 may be configured to transmit, receive, or otherwise exchange UWB data or UWB signals using the respective UWB devices 308 on the first device 302 and/or peripheral device 304. In some embodiments, the first device 302 may be configured to establish a communications link with a peripheral device 304 (e.g., without any device pairing). For example, the first device 302 may be configured to detect, monitor, and/or identify peripheral devices 304 located in the environment using UWB signals received from the peripheral devices 304 within a certain distance of the first device 302, by identifying peripheral devices 304 which are connected to a shared Wi-Fi network (e.g., the same Wi-Fi network to which the first device 302 is connected), etc. In these and other embodiments, the first device 302 may be configured to transmit, send, receive, or otherwise exchange UWB data or signals with the peripheral device 304.

In some embodiments, the first device 302 may recognize one or more peripheral devices 304 and initiate a communication link. For example, the first device 302 may be preconfigured with peripheral devices 304 identified as reliable, safe, etc.

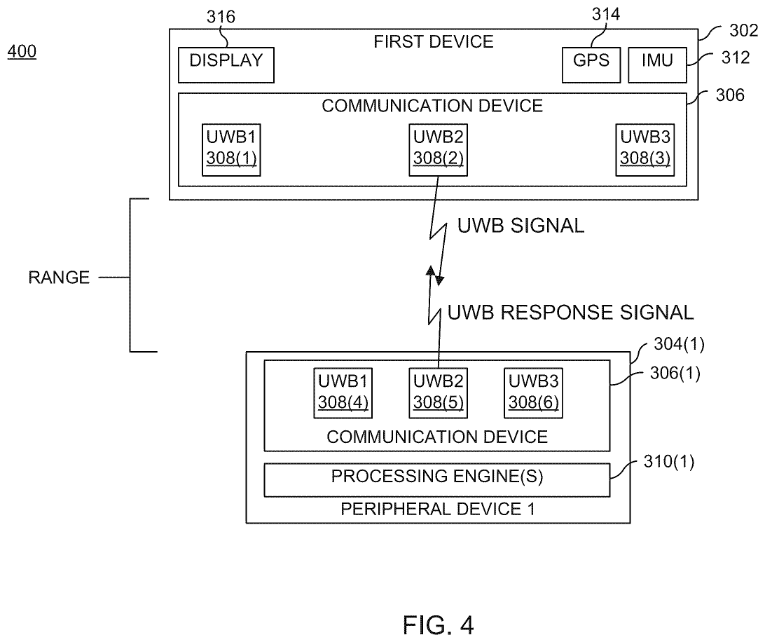

Referring now to FIG. 4, depicted is a block diagram of an environment 400 including the first device 302 and a peripheral device 304. The first device 302 and/or the peripheral device 304 may be configured to determine a range (e.g., a spatial distance, separation) between the devices 302, 304. The first device 302 may be configured to send, broadcast, or otherwise transmit a UWB signal (e.g., a challenge signal). The first device 302 may transmit the UWB signal using one of the UWB devices 308 of the communication device 306 on the first device 302. The UWB device 308 may transmit the UWB signal in the UWB spectrum. The UWB signal may have a high bandwidth (e.g., 500 MHz). As such, the UWB device 308 may be configured to transmit the UWB signal in the UWB spectrum (e.g., between 3.1 GHz and 10.6 GHz) and having a high bandwidth (e.g., 500 MHz). The UWB signal from the first device 302 may be detectable by other devices within a certain range of the first device 302 (e.g., devices having a line of sight (LOS) within 200 m of the first device 302). As such, the UWB signal may be more accurate for detecting range between devices than other types of signals or ranging technology.

The peripheral device 304 may be configured to receive or otherwise detect the UWB signal from the first device 302. The peripheral device 304 may be configured to receive the UWB signal from the first device 302 via one of the UWB devices 308 on the peripheral device 304. The peripheral device 304 may be configured to broadcast, send, or otherwise transmit a UWB response signal responsive to detecting the UWB signal from the first device 302. The peripheral device 304 may be configured to transmit the UWB response signal using one of the UWB devices 308 of the communication device 306 on the peripheral device 304. The UWB response signal may be similar to the UWB signal sent from the first device 302.

The first device 302 may be configured to detect, compute, calculate, or otherwise determine a time of flight (TOF) based on the UWB signal and the UWB response signal. The TOF may be a time or duration between a time in which a signal (e.g., the UWB signal) is transmitted by the first device 302 and a time in which the signal is received by the peripheral device 304. The first device 302 and/or the peripheral device 304 may be configured to determine the TOF based on timestamps corresponding to the UWB signal. For example, the first device 302 and/or peripheral device 304 may be configured to exchange transmit and receive timestamps based on when the first device 302 transmits the UWB signal (a first TX timestamp), when the peripheral device receives the UWB signal (e.g., a first RX timestamp), when the peripheral device sends the UWB response signal (e.g., a second TX timestamp), and when the first device 302 receives the UWB response signal (e.g., a second RX timestamp). The first device 302 and/or the peripheral device 304 may be configured to determine the TOF based on a first time in which the first device 302 sent the UWB signal and a second time in which the first device 302 received the UWB response signal (e.g., from the peripheral device 304), as indicated by first and second TX and RX timestamps identified above. The first device 302 may be configured to determine or calculate the TOF between the first device 302 and the peripheral device 304 based on a difference between the first time and the second time (e.g., divided by two).

In some embodiments, the first device 302 may be configured to determine the range (or distance) between the first device 302 and the peripheral device 304 based on the TOF. For example, the first device 302 may be configured to compute the range or distance between the first device 302 and the peripheral device 304 by multiplying the TOF and the speed of light (e.g., TOF×c). In some embodiments, the peripheral device 304 (or another device in the environment 400) may be configured to compute the range or distance between the first device 302 and peripheral device 304. For example, the first device 302 may be configured to transmit, send, or otherwise provide the TOF to the peripheral device 304 (or other device), and the peripheral device 304 (or other device) may be configured to compute the range between the first device 302 and peripheral device 304 based on the TOF, as described above.

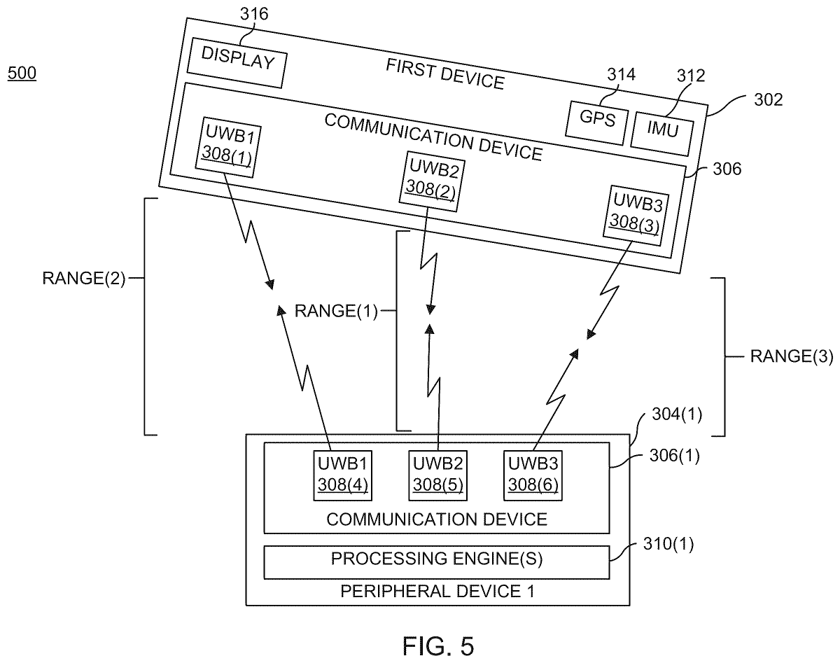

Referring now to FIG. 5, depicted is a block diagram of an environment 500 including the first device 302 and a peripheral device 304. In some embodiments, the first device 302 and/or the peripheral device 304 may be configured to determine a position or pose (e.g., orientation) of the first device 302 relative to the peripheral device 304. The first device 302 and/or the peripheral device 304 may be configured to determine the relative position or orientation in a manner similar to determining the range as described above. For example, the first device 302 and/or the peripheral device 304 may be configured to determine a plurality of ranges (e.g., range(1), range(2), and range(3)) between the respective UWB devices 308 of the first device 302 and the peripheral device 304. In the environment 500 of FIG. 5, the first device 302 is positioned or oriented at an angle relative to the peripheral device 304. The first device 302 may be configured to compute the first range (range(1)) between central UWB devices 308(2), 308(5) of the first and peripheral device 304. The first range may be an absolute range or distance between the devices 302, 304, and may be computed as described above with respect to FIG. 4.

The first device 302 and/or the peripheral device 304 may be configured to compute the second range(2) and third range(3) similar to computing the range(1), In some embodiments, the first device 302 and/or the peripheral device 304 may be configured to determine additional ranges, such as a range between UWB device 308(1) of the first device 302 and UWB device 308(5) of the peripheral device 304, a range between UWB device 308(2) of the first device 302 and UWB device 308(6) of the peripheral device 304, and so forth. While described above as determining a range based on additional UWB signals, it is noted that, in some embodiments, the first device 302 and/or the peripheral device 304 may be configured to determine a phase difference between a UWB signal received at a first UWB device 308 and a second UWB device 308 (i.e., the same UWB signal received at separate UWB devices 308 on the same device 302, 304). The first device 302 and/or the peripheral device 304 may be configured to use each or a subset of the computed ranges (or phase differences) to determine the pose, position, orientation, etc. of the first device 302 relative to the peripheral device 304. Determining the pose, position, orientation, etc. of the first device 302 relative to the peripheral device 304 based on phase differences between UWB signals at the first device 302 and peripheral device 304 may be considered determining the post, position, orientation, etc. according to an angles of arrival (AoA). For example, the first device and/or the peripheral device 304 may be configured to use one of the ranges relative to the first range(1) (or phase differences) to determine a yaw of the first device 302 relative to the peripheral device 304, another one of the ranges relative to the first range(1) (or phase differences) to determine a pitch of the first device 302 relative to the peripheral device 304, another one of the ranges relative to the first range(1) (or phase differences) to determine a roll of the first device 302 relative to the peripheral device 304, and so forth.

By using the UWB devices 308 at the first device 302 and peripheral devices 304, the range and pose may be determined with greater accuracy than other ranging/wireless link technologies. For example, the range may be determined within a granularity or range of +/− 0.1 meters, and the pose/orientation may be determined within a granularity or range of +/− 5 degrees.

Referring to FIG. 3-FIG. 5, in some embodiments, the first device 302 may include various sensors and/or sensing systems. For example, the first device 302 may include an inertial measurement unit (IMU) sensor 312, global positioning system (GPS) 314, magnetometer (MM) 316, etc. The sensors and/or sensing systems, such as the IMU sensor 312, MINI 316, and/or GPS 314 may be configured to generate data corresponding to the first device 302. For example, the IMU sensor 312 may be configured to generate data corresponding to an absolute position and/or pose of the first device 302. Similarly, the GPS 314 may be configured to generate data corresponding to an absolute location/position of the first device 302. Further, the MINI 316 may be configured to measure magnetic fields and/or magnetic dipoles. The data from the IMU sensor 312, MM 316 and/or GPS 314 may be used in conjunction with the ranging/position data determined via the UWB devices 308 as described above. For example, collecting IMU 312 data and MM 316 data, in addition to UWB data, may allow the first device 302 to achieve a high sample rate relative to the first device 302 location and/or rotation.

In some embodiments, the first device 302 may include a display 316. The display 316 may be integrated or otherwise incorporated in the first device 302. In some embodiments, the display 316 may be separate or remote from the first device 302. The display 316 may be configured to display, render, or otherwise provide visual information to a user or wearer of the first device 302, which may be rendered at least in part on the ranging/position data of the first device 302.

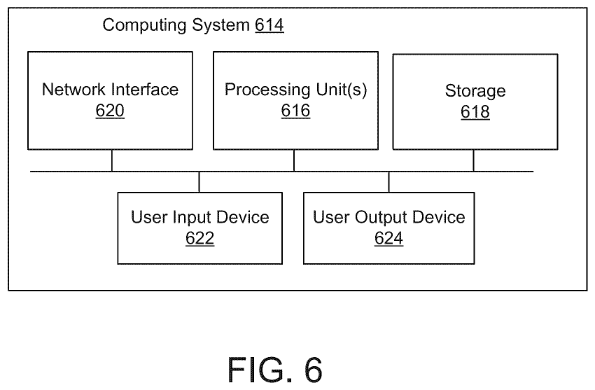

Various operations described herein can be implemented on computer systems. FIG. 6 shows a block diagram of a representative computing system 614 usable to implement the present disclosure. In some embodiments, the computing device 110, the HWD 150, devices 302, 304, or each of the components of FIG. 1-5 are implemented by or may otherwise include one or more components of the computing system 614. Computing system 614 can be implemented, for example, as a consumer device such as a smartphone, other mobile phone, tablet computer, wearable computing device (e.g., smart watch, eyeglasses, head wearable display), desktop computer, laptop computer, or implemented with distributed computing devices. The computing system 614 can be implemented to provide VR, AR, MR experience. In some embodiments, the computing system 614 can include conventional computer components such as processors 616, storage device 618, network interface 620, user input device 622, and user output device 624.

Network interface 620 can provide a connection to a wide area network (e.g., the Internet) to which WAN interface of a remote server system is also connected. Network interface 620 can include a wired interface (e.g., Ethernet) and/or a wireless interface implementing various RF data communication standards such as Wi-Fi, Bluetooth, UWB, or cellular data network standards (e.g., 3G, 4G, 5G, 60 GHz, LTE, etc.).

User input device 622 can include any device (or devices) via which a user can provide signals to computing system 614; computing system 614 can interpret the signals as indicative of particular user requests or information. User input device 622 can include any or all of a keyboard, touch pad, touch screen, mouse or other pointing device, scroll wheel, click wheel, dial, button, switch, keypad, microphone, sensors (e.g., a motion sensor, an eye tracking sensor, etc.), and so on.

User output device 624 can include any device via which computing system 614 can provide information to a user. For example, user output device 624 can include a display to display images generated by or delivered to computing system 614. The display can incorporate various image generation technologies, e.g., a liquid crystal display (LCD), light-emitting diode (LED) including organic light-emitting diodes (OLED), projection system, cathode ray tube (CRT), or the like, together with supporting electronics (e.g., digital-to-analog or analog-to-digital converters, signal processors, or the like). A device such as a touchscreen that function as both input and output device can be used. Output devices 624 can be provided in addition to or instead of a display. Examples include indicator lights, speakers, tactile “display” devices, printers, and so on.

Some implementations include electronic components, such as microprocessors, storage and memory that store computer program instructions in a computer readable storage medium (e.g., non-transitory computer readable medium). Many of the features described in this specification can be implemented as processes that are specified as a set of program instructions encoded on a computer readable storage medium. When these program instructions are executed by one or more processors, they cause the processors to perform various operation indicated in the program instructions. Examples of program instructions or computer code include machine code, such as is produced by a compiler, and files including higher-level code that are executed by a computer, an electronic component, or a microprocessor using an interpreter. Through suitable programming, processor 616 can provide various functionality for computing system 614, including any of the functionality described herein as being performed by a server or client, or other functionality associated with message management services.

It will be appreciated that computing system 614 is illustrative and that variations and modifications are possible. Computer systems used in connection with the present disclosure can have other capabilities not specifically described here. Further, while computing system 614 is described with reference to particular blocks, it is to be understood that these blocks are defined for convenience of description and are not intended to imply a particular physical arrangement of component parts. For instance, different blocks can be located in the same facility, in the same server rack, or on the same motherboard. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Implementations of the present disclosure can be realized in a variety of apparatus including electronic devices implemented using any combination of circuitry and software.

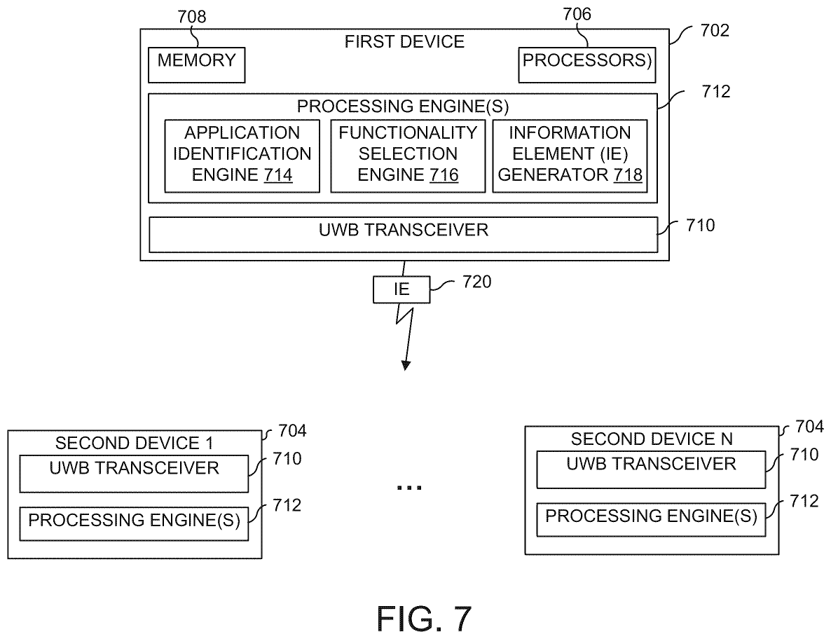

Referring generally to FIG. 7 through FIG. 9, various embodiments described herein are related to systems and methods for ultra-wideband (UWB) configuration for various applications or types. As described above, UWB may support various functionalities in addition to ranging, such as (but not limited to) sensing, data communication, time difference of arrival (TDoA), and the like. In various instances, some embodiments of information element (IE) for control of a UWB session, such as advanced ranging control (ARC) IE, may support various ranging applications. However, it may be challenging to use, for example, an ARC IE for non-ranging applications. For example, there may not be a sufficient number of reserved bits for other functionalities (such as those described above, e.g., sensing, data communication, TDoA, and so forth). Additionally, there may not be configurability on the presence of ranging-specific parameters.

According to the systems and methods described herein, a control IE (or general control IE) may include various control fields for selected application types, a common control field for parameters which are used for all (or most) applications, present bits for each application or functionality which indicates a presence (or absence) of functionality-type specific control fields, and so forth. The control IE may include a length field which indicates a number of bits/bytes/octets/etc. of the control IE. The control IE may include reserved bits for additional functionalities which may be deployed or supported via UWB in the future.

Various embodiments disclosed herein are related to systems and methods for UWB configuration for various applications or types of applications. A first wireless communication device may generate a control IE for configuring one or more functionalities of a plurality of functionalities, for UWB transmissions between the first wireless communication device and a second wireless communication device. The first wireless communication device may transmit a message that includes the control IE to the second wireless communication device. In various embodiments, the functionalities may include, for example, a ranging functionality, a data communication functionality, a sensing functionality, and/or a TDoA functionality. The functionalities may be selected based on a particular application/application type which is executing on the device.

According to the systems and methods described herein, the control IE may configure multiple functionalities which are to be used during a UWB session between two or more devices. Rather than generating multiple IEs for each functionality, the systems and methods described herein may provide a solution which is adaptable for multiple functionalities. Additionally, by providing reserved bits for future functionalities, the control IE described herein may be “future proofed” to support future iterations/deployments/functionalities of UWB. Various other advantages of the systems and methods described herein are described in greater detail below.

Referring now to FIG. 7, depicted is a block diagram of a system 700 for ultra-wideband (UWB) configuration for application or application types, according to an example implementation of the present disclosure. The system 700 may include a first device 702 and any number second devices 704 (referred to generally as a second device 704). The first device 702 may be similar to the first device 302 and the second device 704 may be similar to the peripheral device(s) 304, described above with reference to FIG. 3-FIG. 5. The first device 702 (and second device 704) may include one or more processors 706 and memory 708, which may be similar, respectively, to the processor(s) 118/170 or processing units 616 and storage 618 described above with reference to FIG. 1-FIG. 6. The first device 702 and second device 704 may include respective ultra-wideband (UWB) transceivers 710 and processing engine(s) 712. The UWB transceivers 710 may be similar to the communication device(s) 306, 310 and the processing engine(s) 712 may be similar to the processing engine(s) 310, described above with reference to FIG. 3-FIG. 5.

As described in greater detail below, the first device 702 may be configured to generate/establish an information element (IE) for transmission (in a message) to the second device(s) 704. The IE may manage, negotiate, set, or otherwise configure various functionalities for UWB transmissions between the first device 702 and second device 704. The IE may include, for each functionality to be configured by the IE, corresponding fields for negotiating or configuring the corresponding functionality. The first device 702 may be configured to transmit, send, communicate, or otherwise provide the IE to the second device 704.

The first device 702 and second device 704 may support various UWB functionalities/tasks/functions for communication during a UWB session between the devices 702, 704. The UWB functionalities may be or include functions which are performed using/via UWB signals or transmissions exchanged between the respective UWB transceivers 710. For example, the first device 702 and second device 704 may support a ranging functionality, a sensing functionality, a data communication functionality, a time difference of arrival (TDoA) functionality, and so forth. The ranging functionality may include a UWB function by which the first and second devices 702, 704 exchange various signals for determining a range (or distance) between the respective devices 702, 704. The sensing functionality may include a UWB function by which (for example) the first device 702 embeds, incorporates, or otherwise includes sensing measurements (e.g., from various sensor(s) 155 of the device 702) in UWB signals sent to the second device 704 (and/or vice versa). The data communication functionality may include a UWB function by which the first device 702 embeds, incorporates, or otherwise includes data or a payload in UWB signals sent to the second device 704 (and/or vice versa). The TDoA functionality may include a UWB function by which the first device 702 (or second device 704) measures or determines time differences between received signals from anchor UWB transceiver(s) for determining relative position/angular position relative to the anchor(s). In various embodiments, additional functionalities may be rolled out, provisioned, deployed, or otherwise provided to the first device 702 and second device 704. Such functionalities may be used to support various applications/resources of the devices 702, 704 during a session between the devices 702, 704.

The first device 702 may include a plurality of processing engines 712. The processing engines 712 may be or include any device, component, processor, circuitry, or hardware designed or configured to perform various functions as described herein. The processing engines 712 may include an application identification engine 714, a functionality selection engine 716, and an information element (IE) generator 718. In some embodiments, the processing engines 712 may reside on or execute at an application layer of the device 702. For example, and as described in greater detail below, because the IE generator 718 generates an information element 720 according to various configurations/settings/requirements/targets for a particular application, the IE generator 718 may reside at the application layer and push the IE 720 down to the UWB transceiver 710 for transmission.

The first device 702 may include an application identification engine 714. The application identification engine 714 may be or include any device, component, processor, circuitry, or hardware designed or configured to determine, detect, assess, or otherwise identify an application executing (or to be executed) on the first device 702. In some embodiments, the application identification engine 714 may be configured to identify an application selected by a user of the first device 702, for use during a session with the second device 704. For example, a user of the first device 702 may launch an application via the first device 702, and can initiate a session with the second device 704. The application may be or include any application, program, executable instructions, or resource which can be executed by the first device 702. In some embodiments, the first device 702 may establish sessions with multiple second devices 704, each supporting a different application for a respective session between the first device 702 and second devices 704. As described above, various applications or resources may use or leverage different UWB functionalities. For example, some applications may use a data communication functionality (e.g., a video calling application), some applications may support ranging and TDoA functionalities (e.g., an AR/VR application), and so forth.

The first device 702 may include a functionality selection engine 716. The application identification engine 716 may be or include any device, component, processor, circuitry, or hardware designed or configured to determine, detect, assess, or otherwise identify one or more functionalities to be used during the session between the first device 702 and second device 704. In some embodiments, the functionality selection engine 716 may be configured to determine one or more functionalities to be used for the identified application. In some embodiments, the functionality selection engine 716 may be configured to determine the functionalities based on or according to the application or application type. For example, the functionality selection engine 716 may be configured to use an application identifier for the application (or application type) (e.g., identified by the application identification engine 714) to perform a look-up in a data structure, to identify the corresponding functionalities which are used by the application. In some embodiments, the application may report, select, or otherwise identify the functionalities (e.g., to the functionality selection engine 716) at initialization/launch/start-up, etc.

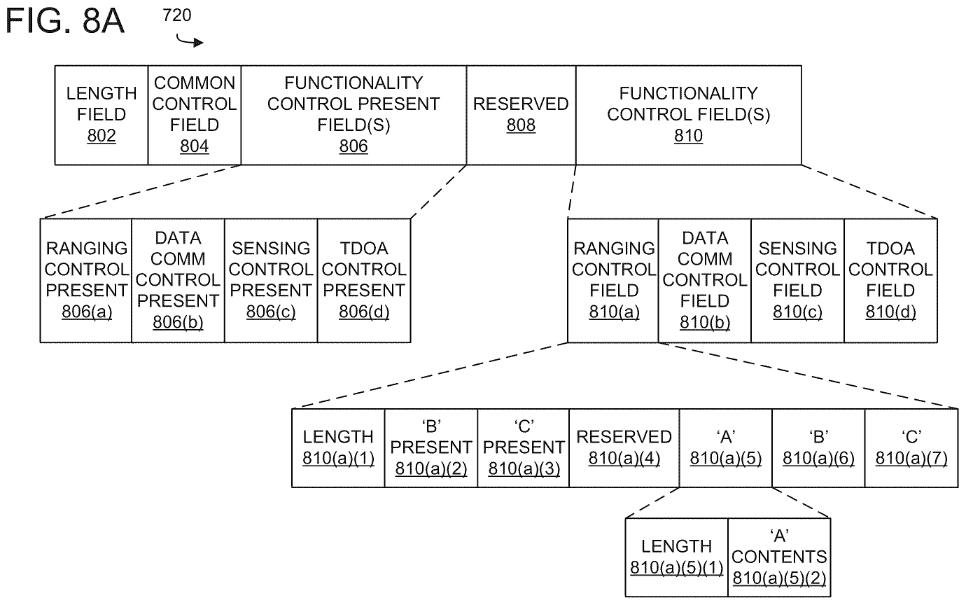

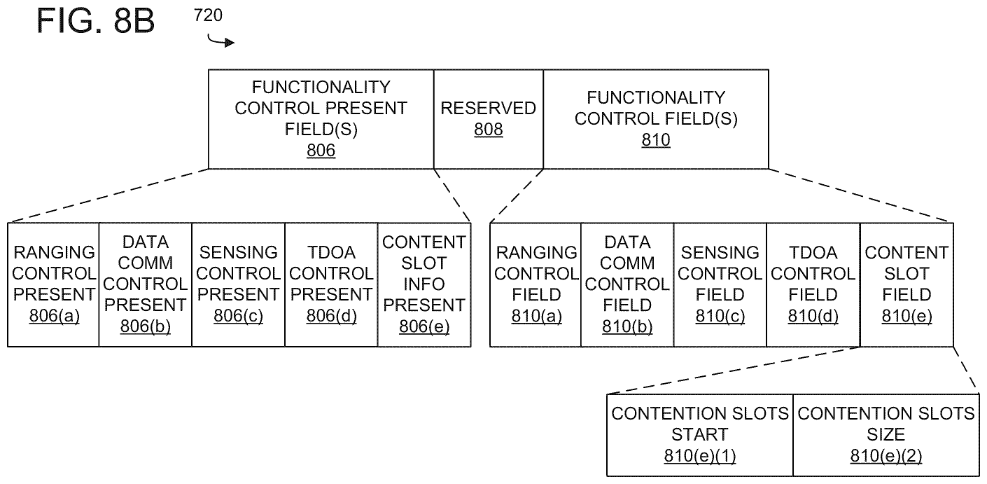

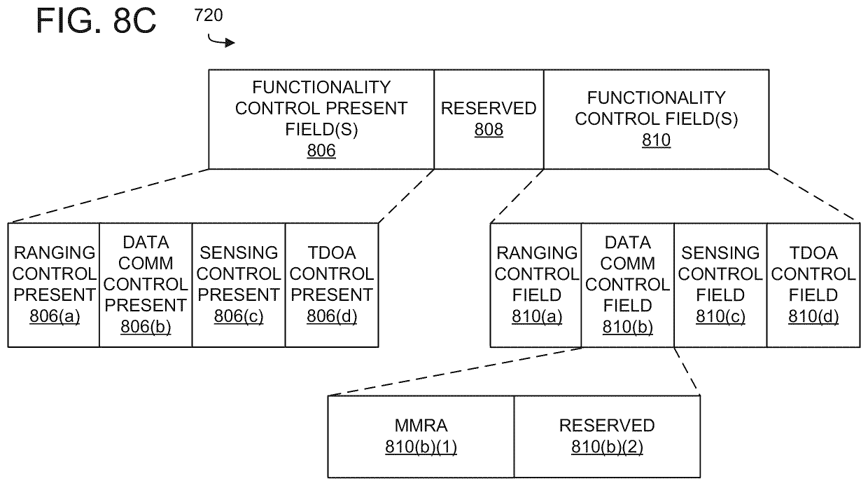

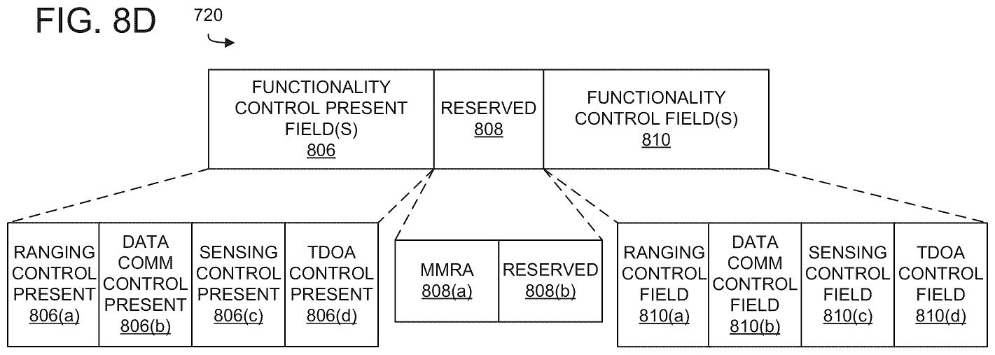

The first device 702 may include an information element (IE) generator 718. The IE generator 718 may be or include any device, component, processor, circuitry, or hardware designed or configured to establish, produce, create, or otherwise generate an IE 720 for transmission to the second device 704. The IE generator 718 may be configured to generate the IE 720, to configure or establish the session between the first device 702 and second device 704. The IE generator 718 may be configured to generate the IE 720 according to each of the one or more functionalities identified or selected by the functionality selection engine 716. The IE generator 718 may be configured to generate the IE 720 to configure or manage the functionalities identified or selected by the functionality selection engine 716. Various example implementations of the IE 720 are described in greater detail below with reference to FIG. 8-FIG. 11.

The first device 702 may be configured to communicate, transmit, send, or otherwise provide the IE 720 to the second device 704. In some embodiments, the first device 702 may be configured to provide the IE 720 to the second device 704 via the respective UWB transceivers 710. In this regard, the first device 702 may be configured to provide the IE 720 in-band (e.g., as a UWB signal according to a UWB protocol) to the second device 704. In some embodiments, the first device 702 may be configured to provide the IE 720 to the second device 704 out-of-band (e.g., via a Wi-Fi signal, a Bluetooth signal, or some other signal generated and sent according to a non-UWB protocol). For example, the first device 702 may be configured to transmit the IE 720 via a Wi-Fi connection to the second device 704, to configure the UWB session between the first device 702 and second device 704.

The second device 704 may be configured to receive the IE from the first device 704. Where multiple second devices 704 are in an environment and targets for establishing a session with the first device 702, each second device 704 may receive the IE from the first device 704. The second device 704 may be configured to receive the IE via the UWB transceiver 710 (and/or via some other transceiver configured for communication via another protocol). The second device 704 may be configured to respond to the IE (e.g., to accept various configurations of the IE 720, to modify various configurations, etc.) as part of a handshake with the first device 702. The first and second device 702, 704 may be configured to establish the UWB session according to the IE 720 (and response). Once established, the first and second device 702, 704 may be configured to communicate with one another according to the configurations of the IE 720. For example the first and second device 702, 704 may be configured to transmit various transmissions for a first functionality (e.g., ranging functionality) in/during the session and transmissions for a second functionality (e.g., data communication functionality) in/during the session, according to the IE 720. Similarly, the first device 702 may be configured to transmit various transmissions for a first functionality in a first set of slots for a session with one of the second devices 704, and may be configured to transmit various transmissions for a second functionality in a second set of slots for another session with another one of the second devices 704.

Referring generally to FIG. 8A-FIG. 8D, depicted are examples of an IE 720 generated by the first device 702, according to example embodiments of the present disclosure. The IE 720 may include a length field 802, a common control field 804, a plurality of functionality control present fields 806, a number of reserved bits 808, and functionality control field(s) 810. The IE generator 718 may be configured to generate the IE 720 according to the functionalities identified/determined/selected by the functionality selection engine 716. While shown in a particular order, it is noted that the present disclosure is not limited to any particular order of fields. Rather, the IE 720 may be organized/ordered in various different ways.

The length field 802 may identify, indicate, or otherwise provide a length (e.g., in bits, bytes, octets, etc.) of the IE 720. In some embodiments, such as where a length of the IE 720 is fixed (e.g., where a particular functionality is not configured, the corresponding functionality control field remain present but do not have any configuration information), the length field 802 may be omitted. The common control field 804 may define, configure, negotiate, or set various parameters which can be applicable or used across UWB functionalities (e.g., independent of any particular functionality). For example, the common control field 804 can be used for defining or configuring parameters relating to a schedule mode (e.g., scheduled-based or contention-based), session identifier, block duration, round duration, slot duration, or various other parameters that may be applicable across UWB functionalities.

The IE 720 can include a plurality of functionality control present fields 806 and corresponding functionality control fields 810. In some embodiments, each functionality control present field 806 may include a corresponding or respective functionality control field 810. For example, as shown in FIG. 8A-FIG. 8D, the IE 720 may include a ranging control present field 806(a) and ranging control field 810(a) for configuring a ranging functionality, a data communication control present field 806(b) and data communication control field 810(b) for configuring a data communication functionality, a sensing control present field 806(c) and sensing control field 810(c) for configuring a sensing functionality, and a TDoA control present field 806(d) and TDoA control field 810(d) for configuring a TDoA functionality. While these four functionalities are represented in the IE 720, it is noted that any number of functionalities (whether now supported or supported in any future deployments/updates for UWB) may be represented in and configured by the IE 720 (e.g., whether through additional control present/control fields 806, 810 or within the reserved bits 808).

The IE generator 718 may be configured to set, update, or otherwise configure the functionality control present fields 806, to identify any functionalities which are to be configured in the IE 720. In some embodiments, the IE generator 718 may be configured to control the functionality control present fields 806 for each of the functionalities selected by the functionality selection engine 716. For example, where the functionality selection engine 716 selects a ranging functionality and a data communication functionality for a particular application or application type, the IE generator 718 may be configured to set the ranging control present field 806(a) and data communication control present field 806(b), to indicate that control information for the corresponding functionalities are present in the IE 720. The IE generator 718 may be configured to set the ranging control present field 806(a) and data communication control present field 806(b) high (or “1”), to indicate a presence of the corresponding control information in the IE 720. For functionalities that are not selected by the functionality selection engine 716, the IE generator 718 may be configured to set the corresponding functionality control present fields accordingly. Continuing the previous example, the IE generator 718 may be configured to set the sensing control present field 806(c) and the TDoA control present field 806(d) low (or “0”), to indicate an absence of the corresponding control information in the IE 720.

The reserved bits 808 may be or include any number of bits which are reserved for supporting/configuring additional functionalities/parameters/etc. of the UWB session between the devices 702, 704. For example, the reserved bits 808 may be used to support newly deployed functionalities or additional functionalities which are released for use in the future. In this regard, the reserved bits 808 may provide flexibility/adaptability for future iterations of UWB functionalities which are developed in addition to those described herein.

The functionality control fields 810 may include fields for providing or configuring parameters relating to a particular UWB functionality which is to be used during the session between the devices 702, 704. The functionality control fields 810 may include, for example, a ranging control field 810(a), a data communication control field 810(b), a sensing control field 810(c), and a TDoA control field 810(d). In some embodiments, functionality control fields 810 for functionalities which are not identified as being present (e.g., based on the associated functionality control present field 806 indicating as such), the functionality control field(s) 810 for such functionality (or functionalities) may be omitted from the IE 720. For example, where the functionality control present field(s) 806 indicate a presence of control fields for ranging control and data communication control functionalities and an absence of sensing control and TDoA control functionalities, the ranging control field 810(a) and data communication control field 810(b) may be included in the IE 720 whereas the sensing control field 810(c) and TDoA control field 810(d) may be omitted. As such, a length of the IE 720 may be dependent on the particular functionalities being configured by the IE 720 (and may be identified in the length field 802). In some embodiments, each of the functionality control fields 810 may be present in the IE 720, regardless of whether or not the IE 720 configures a respective functionality. For example, where the IE 720 indicates an absence of a functionality control field 810 for a particular functionality (e.g., by setting the functionality control present field 806 for the functionality as “0”), the corresponding functionality control field 810 may be included in the IE 720 with an empty set (e.g., all “0” values for the corresponding field 810). As such, the length of the IE 720 in such embodiments may be fixed (and correspondingly, the length field 802 may be omitted from the IE 720).

The functionality control fields 810 may include fields for configuring parameters/settings/a configuration of the corresponding functionality. The functionality control fields 810 may include fields for configuring functionality-specific characteristics/parameters. For example, the ranging control field 810(a) may include fields for setting or configuring a ranging functionality, such as (but not limited to), a multi-node mode, ranging round usage, number of preamble fragments, number of ranging integrity fragments, etc. The data communication control field 810(b) may include fields for setting or configuring a data communication functionality, such as an acknowledgement method (e.g., immediate acknowledgement or delayed acknowledgement), a dynamic or static PHY rate, a number of retransmissions, etc. The sensing control field 810(c) may include fields for setting or configuring a sensing functionality, such as sensing method (e.g., mono-sensing, bi-sensing, multi-static sensing, etc.), number of sensing fragments, channelization of sensing fragments, etc. The TDoA control field 810(d) may include fields for setting or configuring a TDoA functionality, such as TDoA method (e.g., uplink or downlink), timestamp length, anchor location present, etc.

In some embodiments, and as illustrated with respect to the ranging control field 810(a) (though equally applicable to other functionality control fields 810), the functionality control fields 810 may include a length field 810(a)(1), presence fields 810(a)(2)-(3), reserved bits 810(a)(4), and control fields 810(a)(5)-(7). In some embodiments, some fields may be fixed and present in any instance of the corresponding functionality control field 810. For example, as shown with respect to the ranging control field 810(a), field “A” 810(a)(5) may be present or persistent in any instance of a ranging control field 810(a). Some fields may be optional/variable, and indicated as being present or absent in the IE 720 (e.g., by setting the corresponding presence field 810(a)(2)-(3)). The control fields 810(a)(5)-(7) may include a similar length field 810(a)(5)(1) and contents 810(a)(5)(2). The control fields for a respective functionality may include bits representing or configuring the settings/configuration of the corresponding functionality (e.g., those described above for ranging, data communication, sensing, TDoA functionalities).

Referring specifically to FIG. 8B, in some embodiments, the IE 720 may include a contention slots information present field 806(e) and a contention slots information field 810(e). The contention slots information present field 806(e) and contention slots information field 810(e) may be included in the functionality control present fields 806 and functionality control fields 810, respectively. In this regard, the contention slots information present field 806(e) and contention slots information field 810(e) may configure/set/define a contention-based access functionality during the session. The contention slots information present field 806(e) may indicate a presence or absence of contention slots information field 810(e) in the IE 720 (e.g., set to “0” if the contention slots information field 810(e) is absent and set to “1” if the contention slots information field 810(e) is present). The contention slots information field 810(e) may configure, set, or define the contention-based access functionality for the session. The contention slots information field 810(e) may include, for example, a field 810(e)(1) for indicating an index of a content slots starting slot. The index may indicate, for example, a first slot which can be used by the controlee (e.g., the second device 704) without prior scheduling. The contention slots information field 810(e) may include fields 810(e)(2) for configuring the contention slot size, such as the number of slots, starting from the first slot identified by the index in the field 810(e)(1), that can be used without prior scheduling.

Referring specifically to FIG. 8C and FIG. 8D, the IE 720 may include a field for configuring/setting/defining a block acknowledgement to be used during the session. For example, an acknowledgement request (AR) field may be present in a media access control (MAC) header (e.g., indicating whether or not a receiver is to acknowledge the data frame). However, there may not be a protocol on when to use an immediate acknowledgement (imm-ack) or a block acknowledgement (such as a ranging multiple message receipt confirmation information element RMMRC IE or similar block acknowledgement) is to be used. As shown in FIG. 8C, in some embodiments, a multiple message receipt acknowledgement (MMRA) field 810(b)(1) may be included in the data communication control field 810(b) (or in any other control field 810 which may use or benefit from an MMRA). The MMRA field 810(b)(1) may indicate whether or not to use an imm-ack or MMRA. For example, if the MMRA field 810(b)(1) is set to “0”, the receiver may send an imm-ack following an arbitration interframe space (AIFS) after a data frame with the AR field set to “1”. On the other hand, if the MMRA field 810(b)(1) is set to “1”, the receiver may send an RRMRC IE confirming receipt of any number of data frames with AR set to “1”. As shown in FIG. 8D, in some embodiments, the MMRA field 808(a) may be included as one of the reserved bits 808 in the IE 720. In this regard, where the MMRA field 808(a) is included in the reserved bit 808, the MMRA setting or configuration may be applicable to any message/transmission/frame sent on the session with an AR field set to “1”.

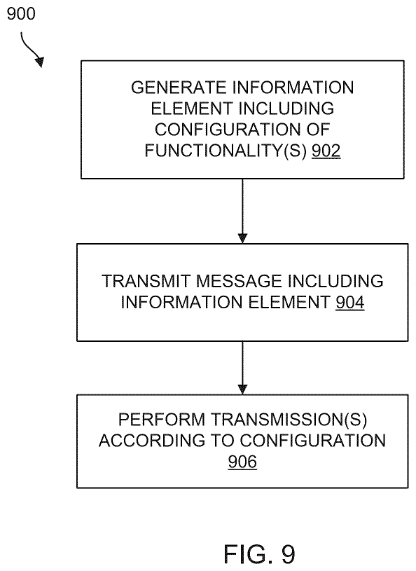

Referring now to FIG. 9, depicted is a flowchart showing an example method 900 of UWB configuration for application types, according to an example implementation of the present disclosure. As a brief overview, at step 902, a first device may generate an information element including a configuration of one or more functionalities. At step 904, the first device may transmit the information element. At step 906, the first device may perform transmissions according to the configuration.

At step 1102, a first device may generate an information element (e.g., a control information element or control IE) including a configuration of one or more functionalities. In some embodiments, the first device may generate the control IE for configuring one or more functionalities of a plurality of functionalities. The functionalities may be used by or supported by ultra-wideband (UWB) transmissions between the first device and a second device. The first device may be the first device 702 described above, the UWB transceiver 710 of the first device 702, etc. Similarly, the second device may be the second device 704, the UWB transceiver 710 of the second device 704, etc. The functionalities may be or include various functionalities which are used or supported by UWB transmissions. For example, the functionalities may include a ranging functionality, a data communication functionality, a sensing functionality, a time difference of arrival (TDoA) functionality, and any other functionality used or supported by UWB transmissions, whether now or in the future.

In some embodiments, the first device may generate the IE based on or according to one or more applications executing on the first device. For example, a user of the first device may request launching of an application on the first device, to establish a session with the second device. The first device may generate the IE responsive to receiving the request. The first device may generate the IE based on or according to a configuration of the first device (e.g., whether or not the first device supports a particular functionality) and targets for the application (e.g., a target frequency or cadence of data transmission, a target frequency or cadence of sensing, etc.). In some embodiments, the first device may generate the IE at an application layer of the device. For example, since the first device generates the IE according to a resource (e.g., application/program/executable/etc.) or resource type and configuration of the first device, the first device may generate the IE at the application layer and push the IE to a UWB transceiver for transmission to the second device, as described in greater detail below.

In some embodiments, the control IE may include a plurality of fields for indicating whether configuration information corresponding to a respective functionality is present in the control IE. For example, the control IE may include a plurality of presence fields indicating a presence (or absence) of control fields for the respective functionality. The first device may set, indicate, or otherwise configure the presence fields for functionalities selected for use during the session (e.g., based on a particular application or application type). The first device may set the presence fields to high (or “1”) to indicate a presence of the corresponding configuration information for a particular functionality, and set the presence fields to low (or “0”) to indicate an absence of corresponding configuration information for a particular functionality. For example, if the control IE is to include configuration information for configuring a first and second functionality but not for configuring a third and fourth functionality, the first device may set presence fields for the first and second functionality to high and set presence fields for the third and fourth functionality to low.

In some embodiments, the presence fields may include a first field for indicating a presence (or absence) of a first functionality, a second field for indicating a presence (or absence) of a second functionality, and so forth. For example, the presence fields may include a first field for indicating whether configuration information relating to ranging control is present in the control IE, a second field for indicating whether configuration information relating to data communication control is present in the control IE, a third field for indicating whether configuration information relating to sensing control is present in the control IE, and/or a fourth field for indicating whether configuration information relating to time difference of arrival control is present in the control IE.

In some embodiments, the control IE may include a plurality of fields for indicating, configuring, setting, or otherwise providing the configuration information for a respective functionality. For example, the control IE may include a plurality of fields for providing configuration information for functionalities which are identified as being present in the presence field. Continuing the previous example, the control IE may include fields for providing configuration information for the first and second functionalities. In some embodiments, the control IE may include fields for providing configuration information for a plurality of functionalities. The plurality of functionalities may be the selected functionalities (e.g., a subset of available functionalities), or each of the available functionalities (e.g., regardless of whether configuration information for a corresponding functionality was indicated as being present in the presence fields). For example, for functionalities where configuration information where the presence field indicates an absence of the configuration information for a functionality, the fields for the configuration information for the respective functionality may be empty set (or each set to “0”). In this regard, the length of the IE may be fixed. On the other hand, in instances where the configuration information included in the IE is limited to the subset of functionalities identified as being present via corresponding presence bits, the length of the IE may be dependent on or a function of the number of functionalities to be configured via respective configuration information. Correspondingly, the length of the control IE may be dependent on the number of the plurality of fields that has a value indicating a presence of the corresponding configuration information. The configuration information may include values for the various fields described above with respect to FIG. 8A-FIG. 8D.

In some embodiments, the IE may include information regarding configuring contention-based communication between the first device and the second device. For example, the first device may generate the IE to include contention information setting, identifying, or otherwise configuring contention-based access of the second device. The contention information may include, for example, an index of a contention slot start and a contention slot size (as described above with reference to FIG. 8B). In some embodiments, the IE may include information regarding configuring an acknowledgement type to be used for acknowledgements between the first device and the second device. For example, the first device may generate the IE to include acknowledgement information setting, identifying, or otherwise configuring an acknowledgement type to be used for acknowledging packets/frames/transmissions. The acknowledgement information may be similar to the acknowledgement information described above with reference for FIG. 8C-FIG. 8D, and can be included in configuration information of various control fields (as shown in FIG. 8C) and/or in reserved bits (as shown in FIG. 8D).

At step 904, the first device may transmit a message including the information element. In some embodiments, the first device may transmit the message including the IE to the second device. The first device may transmit the message including IE responsive to generating the IE at step 902. The first device may transmit the message in a request to establish a session with the second device. The first device may transmit the IE via an in-band signal (e.g., via a UWB signal using the respective UWB transceivers) or via an out-of-band signal (e.g., via a non-UWB signal using a different transceiver or the same transceiver in a different frequency outside of the UWB spectrum).

In some embodiments, the second device may receive the IE from the first device. The second device may receive the IE responsive to the first device transmitting the IE (e.g., via the in-band or out-of-band signal). The second device may generate a response to the IE. In some embodiments, the second device may generate the response as an acknowledgement to the IE. The acknowledgement may accept various fields of the IE, modify/update other fields of the IE, etc., as part of a negotiation/handshake procedure between the devices. The second device may transmit the response to the first device. The first device and the second device may establish a session (e.g., a UWB session) based on or according to the IE and response.

At step 906, the first device may perform transmissions according to the configuration. In some embodiments, the first device may transmit various transmissions, for the respective functionalities, to the second device. For example, assuming that the first device and second device established a session for transmitting UWB transmissions which support ranging and data communication functionalities for a particular application, the IE may configure transmissions for the ranging functionality and transmissions for the data communication functionality. Upon establishing the session, the first device may transmit a first set of transmissions corresponding to the first functionality (e.g., ranging functionality) according to the control field(s) corresponding to the first functionality, and transmit a second set of transmissions corresponding to the second functionality (e.g., data communication functionality) according to the control field(s) corresponding to the second functionality. In this regard, the first device may transmit the transmissions for the corresponding functionality according to the configurations as set/defined/negotiated in the IE.

Having now described some illustrative implementations, it is apparent that the foregoing is illustrative and not limiting, having been presented by way of example. In particular, although many of the examples presented herein involve specific combinations of method acts or system elements, those acts and those elements can be combined in other ways to accomplish the same objectives. Acts, elements and features discussed in connection with one implementation are not intended to be excluded from a similar role in other implementations or implementations.

The hardware and data processing components used to implement the various processes, operations, illustrative logics, logical blocks, modules and circuits described in connection with the embodiments disclosed herein may be implemented or performed with a general purpose single- or multi-chip processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor also may be implemented as a combination of computing devices, such as a combination of a DSP and a microprocessor, a plurality of microprocessors, one or more microprocessors in conjunction with a DSP core, or any other such configuration. In some embodiments, particular processes and methods may be performed by circuitry that is specific to a given function. The memory (e.g., memory, memory unit, storage device, etc.) may include one or more devices (e.g., RAM, ROM, Flash memory, hard disk storage, etc.) for storing data and/or computer code for completing or facilitating the various processes, layers and modules described in the present disclosure. The memory may be or include volatile memory or non-volatile memory, and may include database components, object code components, script components, or any other type of information structure for supporting the various activities and information structures described in the present disclosure. According to an exemplary embodiment, the memory is communicably connected to the processor via a processing circuit and includes computer code for executing (e.g., by the processing circuit and/or the processor) the one or more processes described herein.

The present disclosure contemplates methods, systems and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, for example, instructions and data which cause a general purpose computer, special purpose computer, or special purpose processing machines to perform a certain function or group of functions.

The phraseology and terminology used herein is for the purpose of description and should not be regarded as limiting. The use of “including” “comprising” “having” “containing” “involving” “characterized by” “characterized in that” and variations thereof herein, is meant to encompass the items listed thereafter, equivalents thereof, and additional items, as well as alternate implementations consisting of the items listed thereafter exclusively. In one implementation, the systems and methods described herein consist of one, each combination of more than one, or all of the described elements, acts, or components.

Any references to implementations or elements or acts of the systems and methods herein referred to in the singular can also embrace implementations including a plurality of these elements, and any references in plural to any implementation or element or act herein can also embrace implementations including only a single element. References in the singular or plural form are not intended to limit the presently disclosed systems or methods, their components, acts, or elements to single or plural configurations. References to any act or element being based on any information, act or element can include implementations where the act or element is based at least in part on any information, act, or element.

Any implementation disclosed herein can be combined with any other implementation or embodiment, and references to “an implementation,” “some implementations,” “one implementation” or the like are not necessarily mutually exclusive and are intended to indicate that a particular feature, structure, or characteristic described in connection with the implementation can be included in at least one implementation or embodiment. Such terms as used herein are not necessarily all referring to the same implementation. Any implementation can be combined with any other implementation, inclusively or exclusively, in any manner consistent with the aspects and implementations disclosed herein.

Where technical features in the drawings, detailed description or any claim are followed by reference signs, the reference signs have been included to increase the intelligibility of the drawings, detailed description, and claims. Accordingly, neither the reference signs nor their absence have any limiting effect on the scope of any claim elements.

Systems and methods described herein may be embodied in other specific forms without departing from the characteristics thereof. References to “approximately,” “about” “substantially” or other terms of degree include variations of +/−10% from the given measurement, unit, or range unless explicitly indicated otherwise. Coupled elements can be electrically, mechanically, or physically coupled with one another directly or with intervening elements. Scope of the systems and methods described herein is thus indicated by the appended claims, rather than the foregoing description, and changes that come within the meaning and range of equivalency of the claims are embraced therein.

The term “coupled” and variations thereof includes the joining of two members directly or indirectly to one another. Such joining may be stationary (e.g., permanent or fixed) or moveable (e.g., removable or releasable). Such joining may be achieved with the two members coupled directly with or to each other, with the two members coupled with each other using a separate intervening member and any additional intermediate members coupled with one another, or with the two members coupled with each other using an intervening member that is integrally formed as a single unitary body with one of the two members. If “coupled” or variations thereof are modified by an additional term (e.g., directly coupled), the generic definition of “coupled” provided above is modified by the plain language meaning of the additional term (e.g., “directly coupled” means the joining of two members without any separate intervening member), resulting in a narrower definition than the generic definition of “coupled” provided above. Such coupling may be mechanical, electrical, or fluidic.

References to “or” can be construed as inclusive so that any terms described using “or” can indicate any of a single, more than one, and all of the described terms. A reference to “at least one of ‘A’ and ‘B’” can include only ‘A’, only ‘B’, as well as both ‘A’ and ‘B’. Such references used in conjunction with “comprising” or other open terminology can include additional items.

Modifications of described elements and acts such as variations in sizes, dimensions, structures, shapes and proportions of the various elements, values of parameters, mounting arrangements, use of materials, colors, orientations can occur without materially departing from the teachings and advantages of the subject matter disclosed herein. For example, elements shown as integrally formed can be constructed of multiple parts or elements, the position of elements can be reversed or otherwise varied, and the nature or number of discrete elements or positions can be altered or varied. Other substitutions, modifications, changes and omissions can also be made in the design, operating conditions and arrangement of the disclosed elements and operations without departing from the scope of the present disclosure.

References herein to the positions of elements (e.g., “top,” “bottom,” “above,” “below”) are merely used to describe the orientation of various elements in the FIGURES. The orientation of various elements may differ according to other exemplary embodiments, and that such variations are intended to be encompassed by the present disclosure.

What is claimed is:

1. A method, comprising:
generating, by a first wireless communication device, a control information element (IE) for configuring one or more functionalities of a plurality of functionalities, for ultra-wideband (UWB) transmissions between the first wireless communication device and a second wireless communication device; and
transmitting, by the first wireless communication device, a message that includes the control IE to the second wireless communication device.

2. The method of claim 1, wherein the control IE comprises a plurality of fields for indicating whether configuration information corresponding to a respective functionality of the plurality of functionalities is present in the control IE.

3. The method of claim 2, wherein the plurality of fields comprises at least one of:
a first field for indicating whether configuration information relating to ranging control is present in the control IE;
a second field for indicating whether configuration information relating to data communication control is present in the control IE;
a third field for indicating whether configuration information relating to sensing control is present in the control IE; or
a fourth field for indicating whether configuration information relating to time difference of arrival control is present in the control IE.

4. The method of claim 2, wherein a length of the control IE depends on a number of the plurality of fields that each has a value indicating presence of corresponding configuration information.

5. The method of claim 1, further comprising transmitting, by the first wireless communication device, one or more transmissions with the one or more functionalities to the second wireless communication device, according to the control IE.

6. The method of claim 1, wherein the plurality of functionalities comprises at least one of: ranging, data communication, sensing, or control of time difference of arrival.

7. The method of claim 1, wherein generating the control IE comprises generating, by the first wireless communication device at an application layer, according to a resource of the first wireless communication device and capabilities of the first wireless communication device, the control IE.

8. The method of claim 1, wherein the control IE further comprises information regarding configuring contention-based communication between the first wireless communication device and the second wireless communication device.

9. The method of claim 1, wherein the control IE further comprises information regarding configuring an acknowledgement type to be used for acknowledgements between the first wireless communication device and the second wireless communication device.

10. A first device, comprising:
an ultra-wideband (UWB) transceiver; and
one or more processors configured to:
generate a control information element (IE) for configuring one or more functionalities of a plurality of functionalities, for UWB transmissions between the first device and a second device; and
transmit, via the UWB transceiver, a message that includes the control IE to the second device.

11. The first device of claim 10, wherein the control IE comprises a plurality of fields for indicating whether configuration information corresponding to a respective functionality of the plurality of functionalities is present in the control IE.

12. The first device of claim 11, wherein the plurality of fields comprises at least one of:
a first field for indicating whether configuration information relating to a ranging functionality is present in the control IE;
a second field for indicating whether configuration information relating to a data communication functionality is present in the control IE;
a third field for indicating whether configuration information relating to a sensing functionality is present in the control IE; or
a fourth field for indicating whether configuration information relating to a time difference of arrival functionality is present in the control IE.

13. The first device of claim 11, wherein a length of the control IE depends on a number of the plurality of fields that each has a value indicating presence of corresponding configuration information.

14. The first device of claim 10, wherein the one or more processors are configured to transmit, via the UWB transceiver, one or more transmissions with the one or more functionalities to the second wireless communication device, according to the control IE.

15. The first device of claim 10, wherein the plurality of functionalities comprises at least one of: ranging, data communication, sensing, and control of time difference of arrival.

16. The first device of claim 10, wherein the one or more processors are configured to generate the control IE at an application layer of the first device, according to a resource of the first device and capabilities of the first device.

17. The first device of claim 10, wherein the control IE further comprises information regarding configuring contention-based communication between the first wireless communication device and the second wireless communication device.

18. The first device of claim 10, wherein the control IE further comprises information regarding configuring an acknowledgement type to be used for acknowledgements between the first wireless communication device and the second wireless communication device.

19. A wireless communication device comprising:
an ultra-wideband (UWB) transceiver configured to:
receive a control information element (IE) for configuring one or more functionalities of a plurality of functionalities, for UWB transmissions between the wireless communication device and a second wireless communication device; and
transmit the control IE to the second wireless communication device.

20. The wireless communication device of claim 19, wherein the plurality of functionalities comprises at least one of: ranging, data communication, sensing, and control of time difference of arrival.
